(19) United States
(12) Patent Application Publication
(10) Pub. No.: US 2012/0004764 A1
(43) Pub. Date: Jan. 5, 2012

(54) RECONFIGURABLE MULTI-POCKET DISPENSE DRAWER

(75) Inventors: Michael Rahilly, Encinitas, CA (US); Peter Godlewski, San Clemente, CA (US)

(73) Assignee: CareFusion 303, Inc., San Diego, CA (US)

(21) Appl. No.: 12/828,096

(22) Filed: Jun. 30, 2010

(51) Int. Cl. G06F 17/00; A47B 88/04; G08B 13/14; G06K 7/10; G06K 7/01; A47B 81/00; G06F 7/00

(52) U.S. Cl. 700/225; 312/237; 700/213; 700/237; 235/375; 340/572.1

(57) ABSTRACT

A drawer assembly that includes a cartridge, a drawer configured to receive the cartridge, and a docking connector attached to the drawer. The cartridge includes a body having a plurality of bins, a plurality of lids that are moveably attached to the body and releasably secured over the bins, and a connector attached to the body. The cartridge is configured such that the lids cannot be opened unless a signal is received through the connector. The docking connector is configured to mate with the connector of the cartridge when the cartridge is received in the drawer.

### FIELD

The present disclosure generally relates to systems and methods for dispensing items and, in particular, systems having individually actuated lidded bins suitable for single-item dispensing of medications.

### DESCRIPTION OF THE RELATED ART

Automated dispensing of medications using Automated Dispensing Machines (ADMs) has become common in hospitals around the world. The benefits include a reduction in the pharmacist labor required to dispense the medications as well as enabling nurses to obtain the medications faster as many ADMs are located at the nursing stations. ADMs also provide secure storage of medications, particularly controlled substances, as users must typically identify themselves and the patient to whom the medication will be administered before the ADM will dispense the medication.

One of the challenges of ADMs relates to the method of restocking. ADMs that have fixed drawers require the pharmacist to transport medications to the ADM and load the medications, which both consumes pharmacist time and makes the ADM unavailable to the nurses during the loading process. Another challenge is providing the ability to dispense a single dose of medication, particularly controlled substances, without providing access to a larger stock of the same medications. Existing single-dose dispensing products are complex and, consequently, unreliable or are very inefficient in space usage.

The technology of ADMs is applicable to a wide range of non-medical applications, such as dispensing of consumable cutting tools in a machine shop or tracking of tools while working on an aircraft engine where it is critical to ensure that no tool has been left in the engine. Any application where inventory control is a concern or where the identity of the user must be authenticated prior to allowing access to the contents of the storage system may benefit from the use of ADM technology.

### SUMMARY

The multi-lidded cartridge and the dispensing system disclosed herein provide an elegant and secure method of dispensing items such as medications. The cartridge may be loaded at a remote location such as a pharmacy and securely transported to the ADM by a non-pharmacist and quickly loaded into the ADM, saving pharmacist time and improving the availability of the ADM to nurses. The cartridges provide single-dose dispense capability in a space-efficient manner.

A drawer assembly is disclosed. The drawer assembly includes a cartridge that comprises a body having a plurality of bins, a plurality of lids that are moveably attached to the body and releasably secured over the bins and a connector attached to the body. The cartridge is configured such that the lids cannot be opened unless a signal being received through the connector. The drawer assembly also includes a drawer that is configured to receive the cartridge and a docking connector that is attached to the drawer. The docking connector is configured to mate with the connector of the cartridge when the cartridge is received in the drawer.

In another embodiment, a loading station is disclosed. The loading station includes a base having a docking location configured to receive a removable cartridge having a body with a plurality of bins, a plurality of lids hingedly attached to the body and releasably secured over the plurality of bins, and a connector. The cartridge is configured such that the lids cannot be opened unless a signal is received through the connector. The loading station also includes a docking connector attached to the base, the docking connector configured to mate with the connector of the cartridge when the cartridge is received by the docking location. There is a processor coupled to the docking connector, the processor being configured to send the signal to the cartridge via the docking connector.

In another embodiment, a medication dispensing system is disclosed. The medication dispensing system includes a cartridge having a body comprising a plurality of bins, a plurality of lids that are moveably attached to the body and releasably secured over the bins, and a connector attached to the body. The lids cannot be opened unless a signal is received through the connector. The medication dispensing system also includes a dispensing machine having a housing, a drawer mounted within the housing, and a processor. The drawer is configured to receive the cartridge, the drawer has a docking connector that mates to the connector of the cartridge when the cartridge is received in the drawer assembly. The processor is coupled to the docking connector and configured to send the signal to the cartridge via the docking connector.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a depiction of an ADM used in medical facilities.

FIG. 2 is a perspective view of an ADM drawer containing dispensing cartridges according to certain embodiments of the present disclosure.

FIG. 3 depicts a dispensing cartridge fitting into an ADM drawer according to certain embodiments of the present disclosure.

FIG. 4 shows the same drawer as FIG. 3 with different cartridges installed.

FIG. 5A-5C depict electrical connectors and latching features of the cartridge and drawer of FIG. 2 according to certain embodiments of the present disclosure.

FIG. 6 is a schematic representation of an ADM with a drawer and dispensing cartridges according to certain embodiments of the present disclosure.

FIG. 7 shows an exemplary configuration of a loading station according to certain embodiments of the present disclosure.

FIG. 8 is a schematic of the components of an exemplary loading station according to certain embodiments of the present disclosure.

FIGS. 9A and 9B illustrate recording images of the contents of a cartridge after loading according to certain embodiments of the present disclosure.

FIG. 10 is another embodiment of the loading station configured for a single-bin cartridge according to certain embodiments of the present disclosure.

FIG. 11 is an example of the display of the loading station listing information related to the cartridge being loaded according to certain embodiments of the present disclosure.

FIG. 12 is a flowchart of the process of providing items utilizing the dispensing cartridges according to certain embodiments of the present disclosure.

### DETAILED DESCRIPTION

Pharmacists are under increasing pressure to manage the medications that are provided to nurses and other caregivers in a medical facility. There is an increasing level of regulation, particularly for controlled substances, related to the handling and tracking of medications. Many of these regulations require a pharmacist to perform certain checks on medications, increasing the workload of a pharmacist. Controlled substances, such as medications listed on Schedules I-V of the Controlled Substances Act, may have to be tracked dose by dose from the pharmacy to the patient, which requires significant effort by both pharmacists and nurses. In addition, many hospitals are finding that they cannot find pharmacists to fill open positions, leaving more work for the pharmacists that are on staff. There is therefore a need to manage medications with a reduced amount of pharmacist labor.

Embodiments of the disclosed cartridge, system, and method enable a pharmacist to make medications available to nurses in an ADM at a reduced level of pharmacist effort. The cartridge can be filled and verified by a pharmacist in the pharmacy and then securely transported to an ADM and loaded into the ADM by a non-pharmacist employee such as a pharmacy technician. As the bins cannot be opened when the cartridge is not installed in an ADM or a loading station in the pharmacy, the pharmacist does not need to inspect the cartridge again at the ADM.

Certain exemplary embodiments of the present disclosure include a cartridge having a plurality of bins with individually openable lids. This cartridge is suitable for single-dose dispensing as a single dose of medication may be placed in each bin. Opening a single lid provides the caregiver with access to that single dose without giving the caregiver access to other doses. This eliminates the need for periodic verification counts of the medications, as the opportunity for undetected removal of the medication from the bins has been eliminated.

While the discussion of the cartridge, system, and method is drawn to the dispensing of medications in a hospital, the concepts are applicable to dispensing of medications in other environments as well as the dispensing of other types of items in a variety of fields. For example, machine shops frequently have a tool crib staffed by an individual to provide cutters, drills, and other consumable supplies to the machinists without providing uncontrolled access to the stock of tools and parts. An ADM may be stocked with these consumables and used in place of the tool crib to provide these items to the machinists in a controlled and traceable manner.

In the following detailed description, numerous specific details are set forth to provide a full understanding of the present disclosure. It will be apparent, however, to one ordinarily skilled in the art that embodiments of the present disclosure may be practiced without some of the specific details. In other instances, well-known structures and techniques have not been shown in detail so as not to obscure the disclosure.

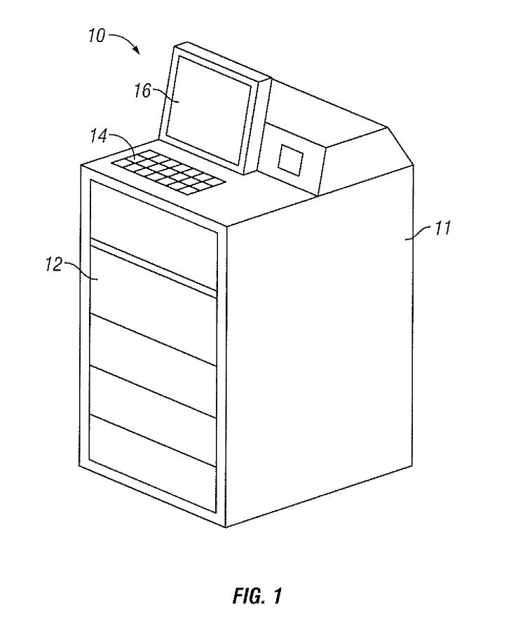

FIG. 1 is a drawing of an ADM for use in medical facilities. This example ADM 10 includes a plurality of drawers 12, some of which may be configured to receive dispensing cartridges (not shown). This configuration of an ADM is often referred to as a cabinet, which includes a housing 11, multiple drawers 12, a variety of electronics and controls (not shown), and the user interface. The user interface of the ADM 10 includes a display 16 and a keyboard 14 so that a user, such as a nurse, may identify which medication they wish to remove from the ADM. The embodiments of the present disclosure may be employed with an otherwise conventional ADM, with a change in the drawer configuration

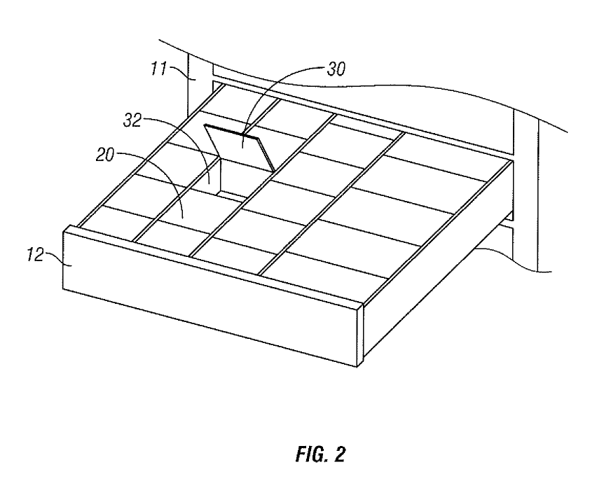

FIG. 2 is a drawing of an ADM drawer 12 containing dispensing cartridges according to certain embodiments of the present disclosure. The drawer 12 is shown installed in housing 11 and configured as if a user has requested a medication that was contained in one of the cartridges placed in drawer 12. One bin of cartridge 20 has been opened by the ADM controller (not shown), revealing lid 30 that covered the bin 32 containing the desired medication. In this example, lid 30 is attached by a hinge to the body of cartridge 20. The lid 30 has a hook or other fastening element (not shown) that enables a latch or other securing mechanism (not shown) within the cartridge 20 to retain the lid 30 in the closed position. The remaining lids 30 remain closed and locked, preventing access to the contents of the other bins.

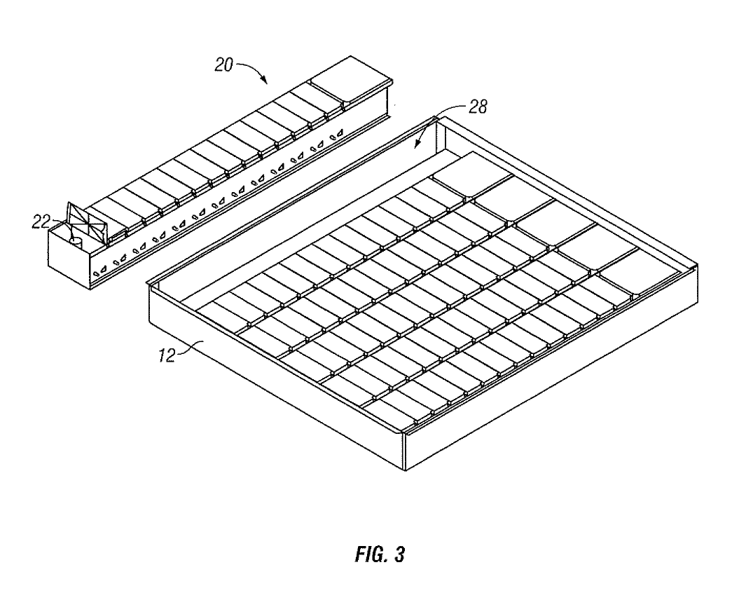

FIG. 3 depicts a dispensing cartridge fitting into an ADM drawer 12 according to certain embodiments of the present disclosure. In this view, a drawer 12 is shown in isolation from the housing 11 of the ADM for clarity. Dispensing cartridges 20 may be provided in a variety of widths. In this example, cartridges 20 are of a width that may be defined as “unit width,” “single width,” or “1×” with a certain number of equal-size bins 22. In the example of FIG. 3, drawer 12 has six 1× spaces 28 occupied by six cartridges 20. Each cartridge 20 occupies the full front-to-back length of drawer 12. While cartridge 20 in this example has fourteen bins of equal length, other embodiments of a cartridge may have more than one size of bin 22 in a single cartridge, and may have fewer or more bins per cartridge compared to cartridge 20.

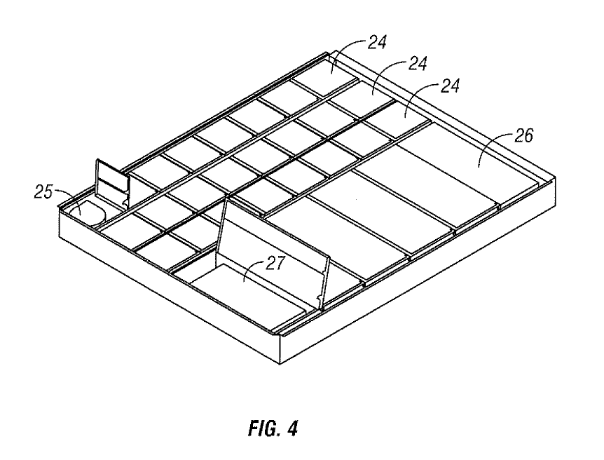

FIG. 4 shows the same drawer 12 as FIG. 3 with different cartridges installed. Cartridges 24 are the same width as cartridge 20 with a reduced number of bins (7 instead of 14), such that the bins are larger and can hold larger items 25. Cartridge 26 is wider than cartridge 20 and has five large bins, enabling each bin to hold a large single item 27 or a quantity of a small item. In some embodiments, wider cartridges are provided in incremental widths that are integer multiples of the 1× width. This enables a user to install a variable configuration of cartridges. In the example of FIG. 4, the drawer 12 has six 1× spaces 28 into which have been installed three “1×” cartridges 24 and one “3×” cartridge 26. Other widths of cartridges may be installed up to, in this example, a single 6× cartridge.

The ability to place any cartridge 20, 24, or 26 into different locations 28 of different drawers 12 in an ADM 10 provides greater flexibility in the use of the ADM 10. As the cartridges 20,24,26 are secure during transportation, a pharmacist is not required to load new medications into an ADM 10, reducing the wait time for an out-of-stock situation to be corrected. If a user wishes to load a 2× cartridge into a drawer 12 without two adjacent open positions 28, the user may reconfigure the ADM 10 and reposition existing cartridges 20,24,26 to create a suitable open location without loss of accessibility to the contents of the repositioned cartridges 20,24,26 as the ADM 10 will reconnect to each cartridge in the new location. Furthermore, it is not necessary to keep a wide cartridge 26, such as 3× or larger, in the ADM if the items of that size are not currently used. The wide cartridge 26 can be removed and the positions 28 utilized for other medications. When needed, the large cartridge 26 can be returned and installed in the ADM 10.

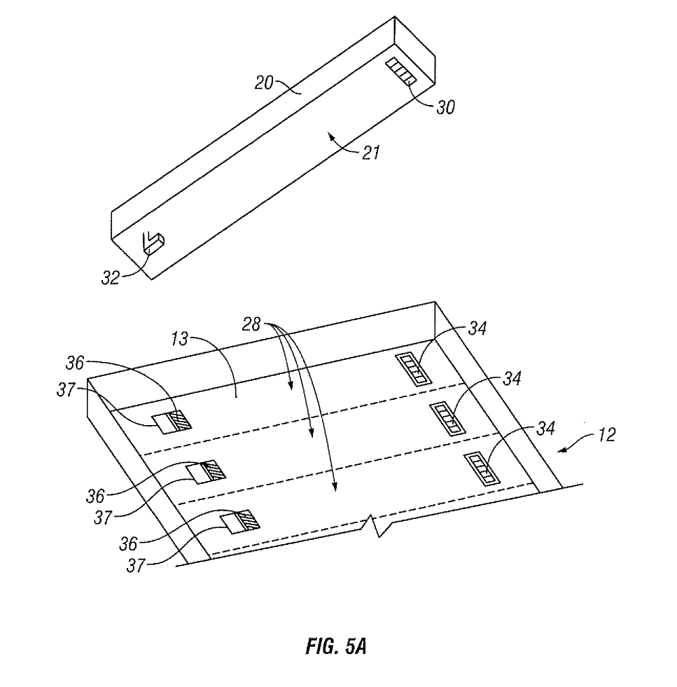

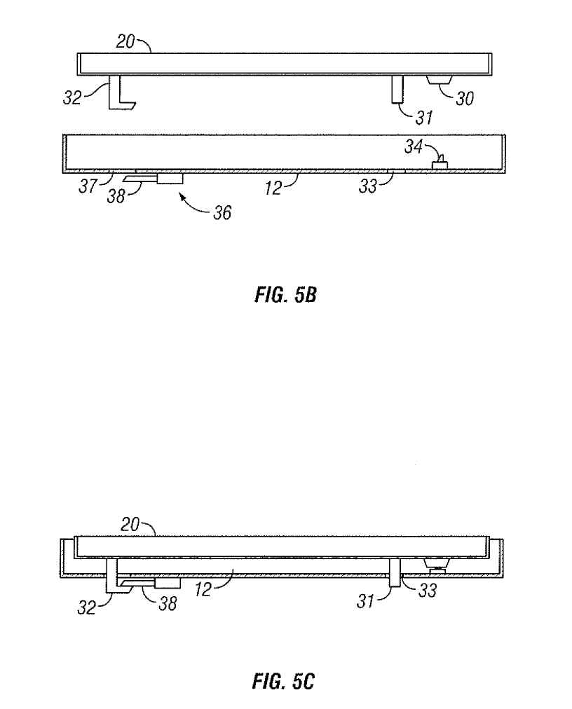

FIG. 5A shows electrical connector and latching features of the cartridge 20 and drawer 12 according to certain embodiments of the present disclosure. Cartridge 20 has been rotated from the view of FIG. 3 to expose the underside 21 which mates with the bottom 13 of drawer 12. In this example, a connector 30 is located near one end of cartridge 20 and is shown as having multiple contacts. A series of mating docking connectors 34 are located on the bottom of drawer 12 such that cartridge 20,24,26 may be placed in any of the locations 28 and mate with one of the docking connectors 34. Power and signals are passed through these connectors between the cabinet and the electronics within cartridge 20, including signals to open one or more of the lids. At the other end from the connector, the example cartridge 20 has a retention feature 32 that, in this example, is a hook that is attached to the underside of the body. Retention feature 32 mates with an engagement element 36 that, in this example, is a latch. In certain embodiments, location 28 has a docking connector 34 and an engagement feature 36 such that a cartridge 20 can be loaded interchangeably into any location 28. When a cartridge 20,24,26 is placed in drawer 12, an engagement feature 36 will engage retention feature 32 and prevent the cartridge 20 from being removed from the drawer 12. Engagement feature 36 is coupled to the ADM processor 15 of FIG. 6 and releases retention feature 32 upon a command from the processor 15, whereupon the cartridge 20 can be removed from drawer 12.

FIGS. 5B and 5C are cross-sections of a drawer 12 and cartridge 20 showing how the electrical connector 30 and retention feature 32 of the cartridge 20 mate with the docking connector 34 and engagement element 36 of the drawer 12 according to certain embodiments of the present disclosure. Cartridge 20 and drawer 12 may have, in certain embodiments, matching alignment features such as post 31 attached to the bottom of cartridge 20 and hole 33 in the bottom of drawer 12. These alignment features engage and locate cartridge 20 relative to the drawer 12 before the connector 20 comes into contact with docking connector 34, thereby reducing the possibility of lateral motion between the connectors 20,34 that might damage the connectors 20,34. The retention feature 32 is, in this example, a hook attached to the body of cartridge 20. As the cartridge 20 is lowered into drawer 12, the retention feature 32 passes through hole 37 in the bottom of drawer 12. An engagement element 36, which is a sliding spring-loaded latch in this example, is attached to the underside of drawer 12. It can be seen that the tip of hook 32 and the tip of the spring-loaded sliding portion of latch 36 have complementary angles such that hook 32 will compress the spring-loaded sliding portion 38 of latch 36 as the hook descends through hole 37. When the flat portion of hook 32 passes by the sliding portion 38 of latch 36, the sliding portion 38 will move forward and engage the hook 32. At this point, cartridge 20 cannot be removed until latch 36 is commanded to retract and release the hook 32.

FIG. 6 is a schematic representation of an ADM 10 with a drawer 12 and dispensing cartridges 20 according to certain embodiments of the present disclosure. The ADM 10 has a processor 15 that is coupled to the drawer 12 and through drawer 12 to cartridge 20 and to engagement element 36. Drawer 12 may incorporate a second processor or simply provide cabling to connect processor 15 to the cartridge 20, and cartridge 20 may incorporate a third processor or simply provide an electrical coupling between the drawer 12 and the lid securing mechanism 35. Processor 15 sends a signal to cartridge 20 to open lid 30 and to engagement feature 36 to release cartridge 20. Processor 15 is also in communication with input device 14 and display 16 whereby a user may input a request for an item stored in one of the cartridges.

Processor 15 is connected to memory 13 and also connected to communication module 17 and thereby to network 18 and database 19. Processor 15 may store or retrieve information related to cartridge 20 in memory 13 or database 19.

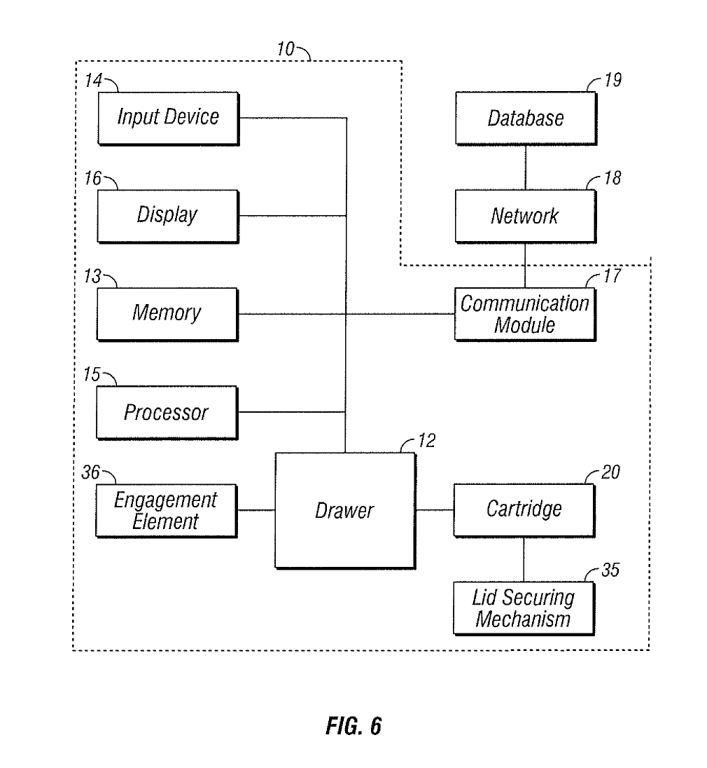

FIG. 7 shows an exemplary configuration of a loading station 40 according to certain embodiments of the present disclosure. The example loading station 40 has a base 42 with a docking location 44 configured to accept, in this example, a cartridge 20. In other embodiments, the docking location 44 is configured to accept a variety of cartridge widths up to the largest width available. Docking location 44 has a docking connector 46 and an engagement element 48 positioned to mate with the connector (not shown) and retention feature (not shown), respectively, of cartridge 20. The loading station 40 includes a user input device 52, shown in FIG. 7 as a keyboard for example, and a display 50. The example embodiment of FIG. 7 is particularly suited for desktop use and other configurations may be more adapted for use on mobile carts, workstations, and other locations.

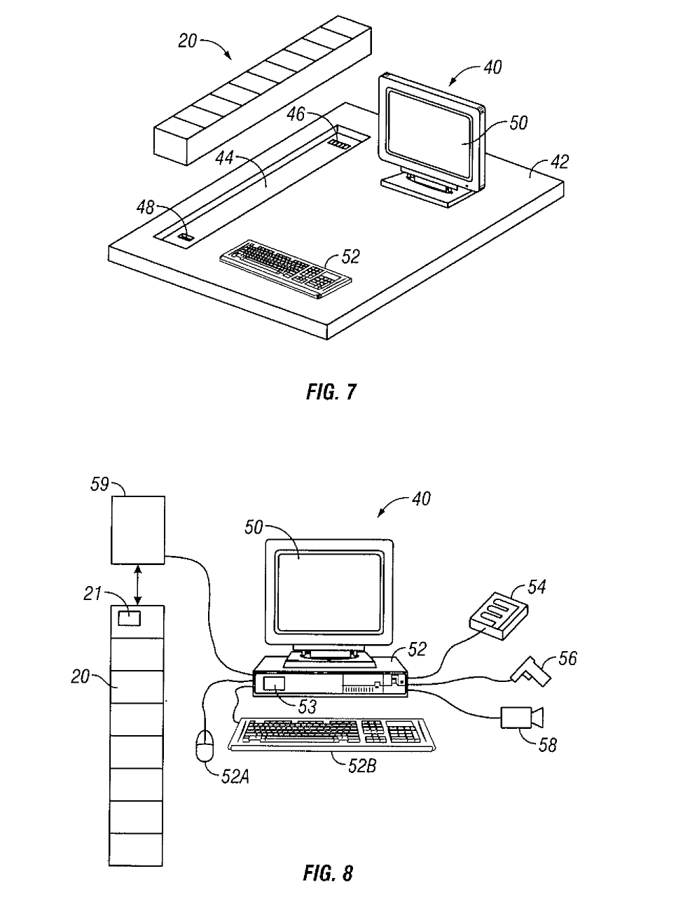

FIG. 8 is a schematic of the components of an exemplary loading station 40 according to certain embodiments of the present disclosure. In this embodiment, the processor 52 has a number of input devices attached to it, including display 50, a Radio Frequency IDentification (RFID) scanner 54, an optical scanner 56 such as a barcode scanner, and a image capture device 58 such as a camera. The user input device 52 of FIG. 7 has been expanded to include a mouse 52A and a keyboard 52B in FIG. 8. A cartridge 20 is connected through an input/output box 59 to the processor 52 such that signals may be sent from the processor to the latching mechanisms in cartridge 20.

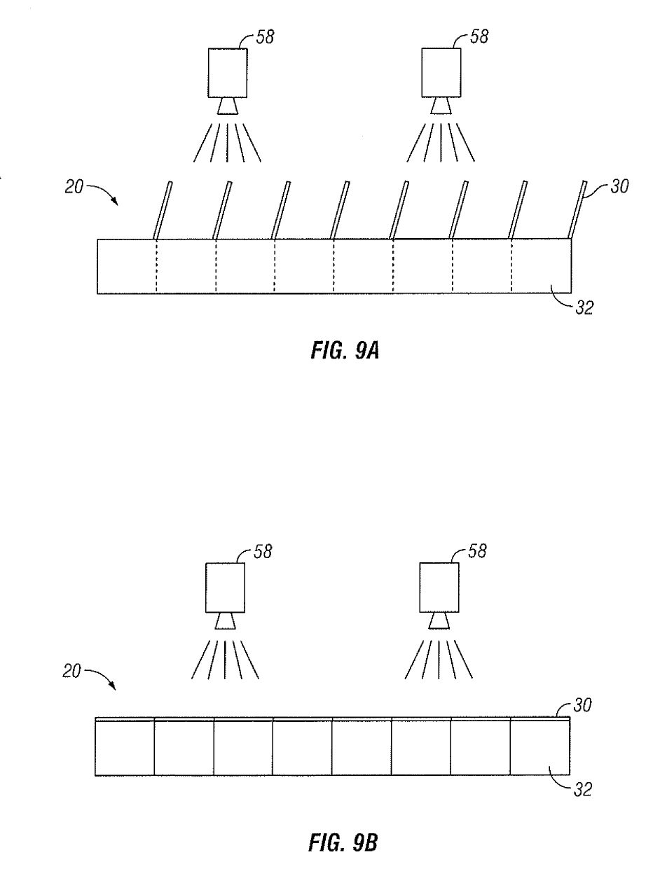

FIGS. 9A and 9B illustrate how images are recorded of the contents of a cartridge 20 after loading according to certain embodiments of the present disclosure. In these examples, two image capture devices 58 are mounted over the cartridge 20 such that the contents of bins 32 are visible. In this example of FIG. 9A, all of the lids 30 are open. In FIG. 9B, the lids 30 are clear such that the contents of bins 32 are visible through the closed lids 30, and the image capture devices 58 can capture an image of the contents of each bin 32 after the lid 30 has been closed and secured. Capturing the image after lid 30 is secured ensures that nothing is added or removed from a bin after the image is recorded. In certain embodiments, the engagement element 48 (not shown) of the docking station 40 remains engaged with the retention feature 32 (not shown) until all the lids 30 are closed and secured and images of each bin 32 have been received and stored by processor 52 in memory 53 or database 19, providing an absolute record of the contents of each bin 32 at the completion of the loading. After the images are stored, processor 52 sends a signal to engagement element 48 to release the retention feature 32.

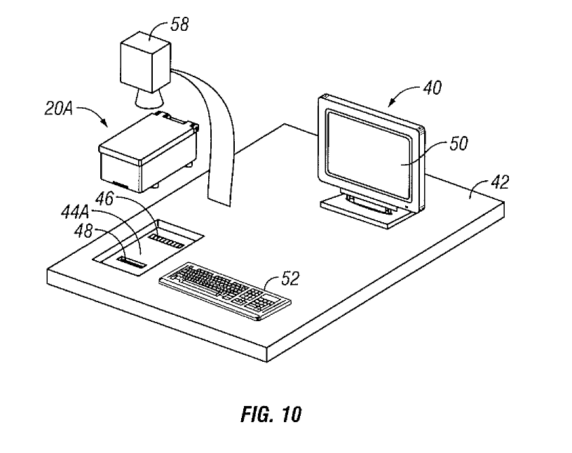

FIG. 10 is another embodiment of the loading station configured for a single-bin cartridge according to certain embodiments of the present disclosure. Similar to the loading station of FIG. 7, this loading station 40 has a base 42 with a docking location 44A configured to accept, in this example, a single-bin cartridge 20A. The docking connector 46, engagement element 48, display 50 and input device 52 are identical. This embodiment includes a image capture device 58 configured to view the bin of cartridge 20A when the cartridge 20A has been received by docking location 44A. The image capture device may take an image while the lid is open or, in an alternate configuration, the image must be taken after the lid is closed. The system may not release engagement element 48 until the image has been taken and stored.

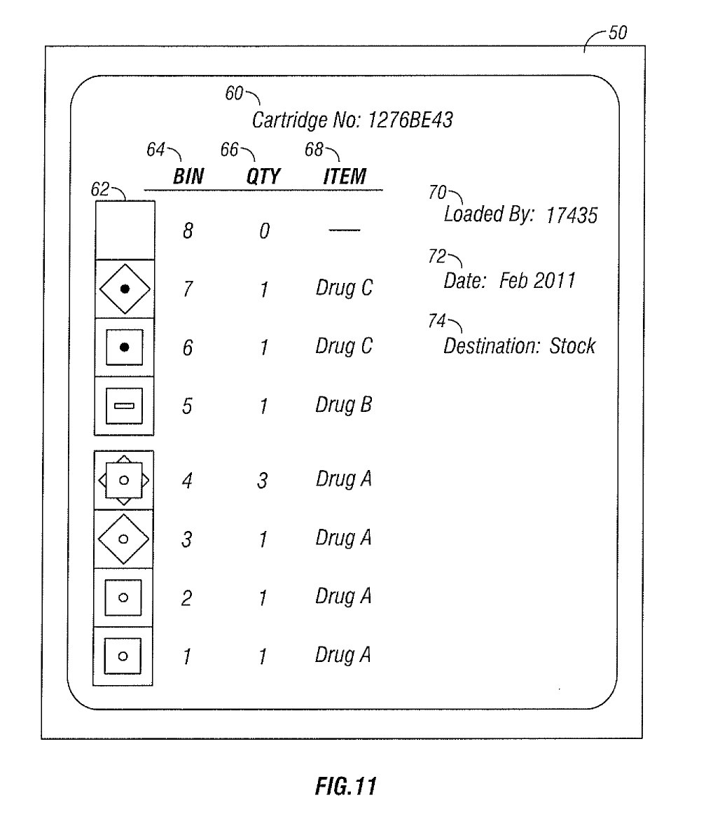

FIG. 11 is an example of the display 50 of the loading station 40 listing information related to the cartridge 20 being loaded according to certain embodiments of the present disclosure. The example screen has a column of “thumbnail” images 62 of each bin on the left. From left to right, the display lists the bin number 64, the quantity of items 66 in each bin, and a descriptor 68. On the right side of the display 50, the identity 70 of the person loading the cartridge 20 is listed, the date 72, and the anticipated destination 74. The cartridge identifier 60 is listed at the top of the display 50. This information, including the images 62 taken after the lids 30 were closed and secured, form a record of what was loaded into the cartridge 20 for inventory management and auditing purposes. Other embodiments may allow or require entry of other data related to the item to be loaded into the cartridge such as a quantity, a volume, a dimension, an identification, a serial number, a lot number, an expiration date, a dosage, a patient identifier, an administration order identifier, a cartridge identifier, an identification of the bin of the cartridge 20 into which the item will be placed, an image, a date, and an identification of the operator using the loading station 40. In some embodiments, this data is stored in a memory 21 embedded in the cartridge 20 while, in other embodiments, the data is stored in database 19.

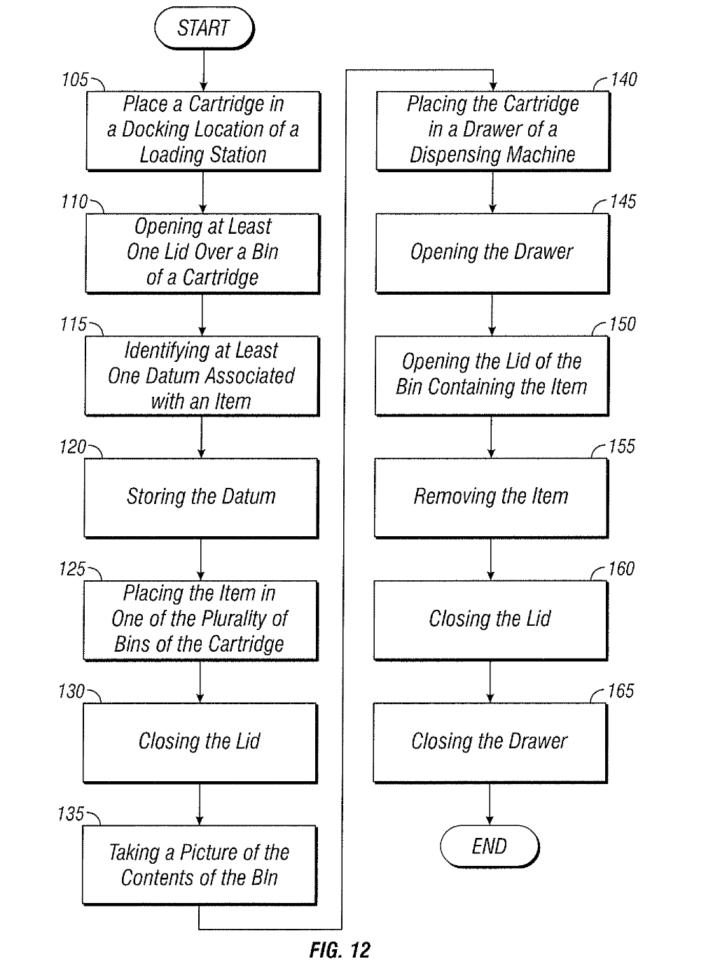

FIG. 12 is a flowchart that describes the process of providing items utilizing dispensing cartridges 20 according to certain embodiments of the present disclosure. In step 105, a cartridge 20 is placed on the docking location 44 of a loading station 40. The operator opens at least one lid 30 per step 110. The operator will identify at least one datum associated with an item to be placed in the cartridge 20. This may be accomplished in a variety of ways such as scanning a barcode on the item with a barcode scanner 56, passing the item over a RFID reader 54 and reading information from a RFID tag that is attached to the item, or entering information manually using the keyboard 52B. Additional information may be retrieved from memory 53 or a remote database 19. The datum is stored in step 120, which may include local memory 53 or transmittal to database 19. The item is then placed in one of the bins 22 of the cartridge 20, as in step 125, and the lid 30 closed in step 130. An image is recorded in step 135 of the contents of at least the bin 22 to which the item was added. As the lid 30 cannot be opened without a command from the processor 52, this image is a high-confidence record of the cartridge 20 contents. The cartridge 20 is now configured for secure storage and transport. The cartridge 20 may be placed in inventory for a time until needed, whereupon a single cartridge 20 may be transported to the location where it is needed. At that time, the cartridge 20 is loaded into a drawer 12 of an ADM 10 or similar device, as stated in step 140. The cartridge 20 may be loaded into any open location 28 in any drawer 12 configured to accept cartridges 20. In this example, a nurse wishes to remove the item from the ADM 10. After logging in and identifying the desired item to the ADM 10, the user opens the drawer 12 in step 145 and, in step 150, the ADM 10 releases the lid 30 of the bin 22 containing the item. In some configurations, the lid 30 may self-open while, in other configurations, the user may have to open the released lid 30. In step 155, the user removes the item and, in steps 160 and 165, closes the lid 30 and then closes the drawer 12, returning the ADM 10 to its secure configuration. The nurse has the item that she needed and the system has a record of the removal of the item. Additional information related to the patient 10 for whom the item is intended as well as the identification of the nurse who removed the item may be recorded at the same time.

In summary, dispensing cartridges and reconfigurable drawers have been disclosed. The cartridges are interchangeably positionable in any open docking position of a drawer that is configured to accept the cartridges. The drawers may be reconfigured and the cartridges moved to new positions within a drawer, between the drawers of an ADM, or between ADMs without loss of tracking or availability of the contents of the relocated cartridges or risk of undetected access to the contents of the cartridge.

A loading station for use with the dispensing cartridges is also disclosed. The loading station provides the ability to identify the contents of each bin of a cartridge and create a high-confidence record of the contents of each bin by recording an image of the bin after the lids are closed and secured. As the lids may be opened only by a command signal through the cartridge connector, the cartridges are secure during handling and may be transported by non-pharmacist personnel without loss of confidence in the knowledge of the contents of the cartridge.

The previous description is provided to enable any person skilled in the art to practice the various aspects described herein. While the foregoing has described what are considered to be the best mode and/or other examples, it is understood that various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

The term “optical” covers electromagnetic radiation from ultraviolet to infrared, including wavelengths in the range of 10 nanometers to 1 millimeter and includes, but is not limited to, light visible to the human eye, which covers the range of 380-760 nanometers.

The phrase “bar code” includes all optically-readable encoding schemes using lines of various thicknesses, such as the Universal Product Code (UPC), Code 128, 2D matrix codes and symbologies such as Aztec Code, MaxiCode, and DataGlyphs, and optical-character recognition of human-readable alphanumeric strings.

The phrase “Radio Frequency Identification” and the acronym “RFID” include systems wherein a scanner having an antenna communicates wirelessly with multiple devices, or tags, that are equipped with antennas for the purpose of retrieving one or more items of information related to the tag or an item to which the tag is attached. This communication may occur at any frequency with the band of 3 kHz to 300 GHz. The tag may be passive, i.e. drawing power from the electromagnetic field created the scanner antenna, or active, having a power source which may be internal, such as a battery, or external, such as a power coupling to a second device.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. A phrase such an embodiment may refer to one or more embodiments and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A drawer assembly, comprising:
a cartridge comprising:
a body comprising a plurality of bins;
a plurality of lids that are moveably attached to the body and releasably secured over the bins; and
a connector attached to the body;
wherein the cartridge is configured such that the lids cannot be opened unless a first signal is received through the connector;
a drawer configured to receive the cartridge; and
a docking connector attached to the drawer, the docking connector configured to mate with the connector of the cartridge when the cartridge is received in the drawer.

2. The drawer assembly of claim 1, wherein:
a first cartridge has a first width;
the drawer comprises a plurality of receiving positions;
each receiving position comprises one of the docking connectors; and
the plurality of receiving positions are configured to receive a plurality of first cartridges.

3. The drawer assembly of claim 2, wherein:
a second cartridge has a second width greater than the first width;
the plurality of receiving positions are configured to receive at least one second cartridge such that the second cartridge occupies two or more adjacent receiving positions; and
the connector of the second cartridge mates with the docking connector at one of the two or more occupied receiving positions.

4. The drawer assembly of claim 1, wherein:
the cartridge further comprises a retention feature attached to the body;
the drawer further comprises an engagement element movably attached to the drawer; and
the engagement element is configured to engage the retention feature of the cartridge when the cartridge is received in the drawer.

5. The drawer assembly of claim 4, wherein the engagement element is further configured to release the retention feature of the cartridge upon receipt of a second signal.

6. The drawer assembly of claim 5, wherein the drawer further comprises a controller coupled to the engagement element and configured to send the second signal to the engagement feature.

7. The drawer assembly of claim 1, wherein the drawer further comprises a controller coupled to the docking connector and configured to send the first signal to the cartridge via the docking connector.

8. A loading station, comprising:
a base having a docking location configured to receive a removable cartridge having:
a body with a plurality of bins;
a plurality of lids hingedly attached to the body and releasably secured over the plurality of bins; and
a connector;
wherein the cartridge is configured such that the lids cannot be opened unless a first signal is received through the connector;
a docking connector attached to the base, the docking connector configured to mate with the connector of the cartridge when the cartridge is received by the docking location; and
a processor coupled to the docking connector, the processor configured to send the first signal to the cartridge via the docking connector.

9. The loading station of claim 8 further comprising an input device coupled to the processor, wherein the processor is further configured to accept via the input device at least one datum related to the item to be loaded into the cartridge and to store the datum.

10. The loading station of claim 9 wherein the datum comprises at least one of a quantity, a volume, a dimension, an identification, a serial number, a lot number, an expiration date, a dosage, a patient identifier, an administration order identifier, a cartridge identifier, an identification of the bin of the cartridge into which the item will be placed, an image, a date, and an identification of the operator using the loading station.

11. The loading station of claim 9 wherein the input device comprises an optical scanner configured to scan and interpret a machine-readable code associated with the item, and the processor is configured to receive and store the scanned code.

12. The loading station of claim 9 wherein the input device comprises a Radio Frequency IDentification (RFID) scanner configured to read information from a RFID tag associated with the item, and the processor configured to receive and store the scanned information.

13. The loading station of claim 9 wherein the input device comprises an image capture device configured to record an image of one or more of the bins of the cartridge, and the processor is configured to receive and store the image.

14. The loading station of claim 8 wherein:
the cartridge further comprises a retention feature attached to the body;
the loading station further comprises an engagement element movably attached to the base; and
the engagement element is configured to engage the retention feature when the cartridge is received by the docking location.

15. The loading station of claim 14 wherein:
the engagement element is coupled to the processor;
the loading station further comprises a image capture device coupled to the processor, the image capture device configured to record an image of one or more of the bins of the cartridge; and
the processor is further configured to receive and store the image and to send a signal to the engagement element to release the retention feature of the cartridge only after receiving the image.

16. The loading station of claim 15 wherein:
the lids of the cartridge are transparent;
the image capture device is configured to record an image of one or more of the bins of the cartridge through the closed lids of the respective bins; and
the processor is further configured to receive and store the image only after all of the lids are closed and secured.

17. A loading station, comprising:
a base having a docking location configured to receive a removable cartridge having:
a body with a bin and a retention feature attached to the body;
a lid hingedly attached to the body and releasably secured over the bin; and
a connector;
wherein the cartridge is configured such that the lid cannot be opened unless a first signal is received through the connector;
a docking connector attached to the base, the docking connector configured to mate with the connector of the cartridge when the cartridge is received by the docking location;
an engagement element movably attached to the base, the engagement element configured to engage the retention feature when the cartridge is received by the docking location and further configured to release the retention feature upon receipt of a second signal;
a processor coupled to the docking connector and to the engagement element, the processor configured to send the first signal to the cartridge via the docking connector and further configured to send the second signal to the engagement feature; and
a image capture device coupled to the processor, the image capture device configured to record an image of the bin of the cartridge when the cartridge is received by the docking location;
wherein the processor is further configured to receive and store the image and to send the second signal only after receiving the image.

18. The loading station of claim 17 wherein:
the lid of the cartridge is transparent;
the image capture device is configured to record an image of the bin through the closed lid; and
the processor is further configured to receive and store the image only after the lid is closed and secured.

19. A medication dispensing system, comprising:
a cartridge comprising:
a body comprising a plurality of bins;
a plurality of lids that are moveably attached to the body and releasably secured over the bins; and
a connector attached to the body, wherein the lids cannot be opened unless a first signal is received through the connector; and a dispensing machine comprising:
a housing;
a drawer mounted within the housing, the drawer configured to receive the cartridge, the drawer comprising a docking connector that mates to the connector of the cartridge when the cartridge is received in the drawer assembly, and
a processor coupled to the docking connector, the processor configured to send the first signal to the cartridge via the docking connector.

20. The medication dispensing system of claim 19, wherein:
a first cartridge has a first width;
the drawer comprises a plurality of receiving positions;
each receiving position comprises a docking connector; and
the plurality of receiving positions are configured to receive a plurality of first cartridges.

21. The drawer assembly of claim 20, wherein:
a second cartridge has a second width greater than the first width;
the plurality of receiving positions are configured to receive at least one second cartridge such that the second cartridge occupies two or more adjacent receiving positions; and
the connector of the second cartridge mates with the docking connector of one of the occupied receiving positions.

22. The medication dispensing system of claim 19, wherein:
the cartridge further comprises a retention feature attached to the body; and
the drawer further comprises an engagement element movably attached to the drawer, the engagement element configured to engage the retention feature of the cartridge when the cartridge is received in the drawer.

23. The medication dispensing system of claim 22, wherein:
the engagement element is configured to release the retention feature of the cartridge upon receipt of a second signal; and
the processor is coupled to the engagement element and configured to send the second signal to the engagement feature.

24. The medication dispensing system of claim 19, further comprising a loading station configured to release at least one lid of the cartridge, receive an input of at least one datum, and to store the datum.

25. The medication dispensing system of claim 24, wherein the datum comprises at least one of a quantity, a volume, a dimension, an identification, a serial number, a lot number, an expiration date, a dosage, a patient identifier, an administration order identifier, a cartridge identifier, an identification of the bin of the cartridge into which the item will be placed, an image, a date, and an identification of the operator using the loading station.

26. A method of dispensing items, the method comprising the steps of:
loading at least one item into a cartridge having a body with a plurality of bins and a plurality of lids that are moveably attached to the body and releasably secured over the bins;
connecting the cartridge into a drawer of an automatic dispensing machine (ADM);
requesting the item to be dispensed from the ADM; and
releasing the lid of the bin that contains the item.

27. The method of claim 26, wherein the step of loading at least one item into a cartridge comprises:
placing the cartridge on a docking location of a loading station;
opening at least one lid of the cartridge;
loading the item into the bin associated with the open lid;
accepting input of at least one datum associated with the item;
storing the datum; and
closing and securing the lid.

28. The method of claim 27, wherein the step of loading at least one item into a cartridge further comprises:
recording an image of the contents of the cartridge; and
storing the image.

29. The method of claim 27, wherein the datum comprises at least one of a quantity, a volume, a dimension, an item identifier, a serial number, a lot number, an expiration date, a dosage, a patient identifier, an administration order identifier, a cartridge identifier, and an identification of the bin of the cartridge.
